(19) United States
(12) Patent Application Publication
(10) Pub. No.: US 2025/0070448 A1
(43) Pub. Date: Feb. 27, 2025

(54) ANTENNA STRUCTURE AND BLUETOOTH SENSOR INCLUDING THE ANTENNA STRUCTURE IN TPMS

(71) Applicant: Hamaton Automotive Technology Co.,Ltd, Hangzhou, Zhejiang (CN)

(72) Inventors: Jianer ZHANG, Hangzhou, Zhejiang (CN); Zenan HU, Hangzhou, Zhejiang (CN); Mingguang YU, Hangzhou, Zhejiang (CN)

(73) Assignee: Hamaton Automotive Technology Co.,Ltd, Hangzhou, Zhejiang (CN)

(21) Appl. No.: 18/553,057

(22) PCT Filed: Jul. 31, 2023
(86) PCT No.: PCT/CN2023/110239

§ 371 Date: Sep. 28, 2023

(30) Foreign Application Priority Data
Jul. 6, 2022 (CN) 202221715895.3

(51) Int. Cl. H01Q 1/22; H01Q 9/04

(52) U.S. Cl. CPC H01Q 1/2241; H01Q 9/0414

(57) ABSTRACT

The application discloses an antenna structure for a Bluetooth sensor in a TPMS, including an antenna board and a Bluetooth antenna arranged on the antenna board, where the Bluetooth antenna is an IFA with a backbone distributed in a straight line or a backbone distributed in a serpentine shape; where the antenna board is a PCB, including a ground pin and a signal feed point protruded from an edge of the antenna board; and where the ground pin and the signal feed point are connected with the Bluetooth antenna. The present application further discloses a Bluetooth sensor in a TPMS, including a battery, a tire pressure sensor main board, and the antenna structure as described above, where the antenna structure is vertically installed on the tire pressure sensor main board.

### CROSS-REFERENCE TO RELATED APPLICATIONS

This application is a national stage of international PCT Application No. PCT/CN2023/110239 filed on Jul. 31, 2023, and claims a priority to a Chinese Patent Application with the corresponding application number being 202221715895.3 and the application date being Jul. 6, 2022, the entire contents of which are incorporated herein by reference.

### TECHNICAL FIELD

The present application relates to a field of antennas, and in particular to an antenna structure and a Bluetooth sensor including the antenna structure in a TPMS.

### BACKGROUND

The Bluetooth sensor used in the related tire pressure monitoring system (TPMS) adopts a monopole antenna principle in the antenna design scheme, and an end part of the antenna is made into a coil shape or an inverted L shape, provided with an antenna access feed point. Taking the inverted L antenna as an example, a vibrator of the inverted L antenna is bent and folded to form a ground capacitance component with a printed circuit board ground or component, and its input impedance has an impedance characteristic of low resistance and high impedance, and it is often difficult to perform impedance matching in the circuit. In addition, the capacitive component of the antenna is easily affected by the change of the environmental magnetic field, and the change of the external magnetic field will change the capacitance of the antenna in the related art, and the change of the capacitance will lead to the change of the resonant frequency of the antenna. The Bluetooth sensor in TPMS is generally installed in the tire, close to a rim of a vehicle. When the rim of the vehicle rotates, the Bluetooth sensor is close to the ground. The rim and the ground will change the equivalent capacitance of the antenna in the Bluetooth sensor, thereby affecting the resonant frequency of the antenna. Another disadvantage of the monopole inverted L antenna is that the half-wave vibrator has only one arm. During the entire antenna radiation process, a current loop is formed by the changing electric field (displacement current) of the air medium and the external ground or metal magnetic field substance. When the external air magnetic field is changed (such as when the rim and tire are rotated to ground), it will directly cause the current imbalance at the antenna terminal, and change the tuning frequency and impedance of the antenna, thereby attenuating the transmission of Bluetooth signals. Obviously, this is not the best antenna design for related Bluetooth sensors in TPMS. A new antenna technology to change this situation is required. The new application technology needs to minimize an impact of factors such as metal and ground and the like in the antenna working environment on the antenna performance, and to improve an anti-interference of the antenna, such that the Bluetooth sensor in TPMS is more adaptable for changes in the internal and external environment of the tire, maximizing the signal radiation efficiency.

### SUMMARY

In order to solve shortcomings of the monopole antenna in the related art, the present application provides an antenna structure and a Bluetooth sensor including the antenna structure in TPMS.

The present application is realized through the following technical measures. An antenna structure for a Bluetooth sensor in a tire pressure monitoring system (TPMS) includes an antenna board and a Bluetooth antenna on the antenna board, where the Bluetooth antenna is an Integrated Feed Antenna (IFA) with a backbone distributed in a straight line or a backbone distributed in a serpentine shape; where the antenna board is a Printed Circuit Board (PCB), including a ground pin and a signal feed point that are protruded from an edge of the antenna board, and the ground pin, the signal feed point are connected with the Bluetooth antenna; the antenna board further includes a fixed pin protruded from the edge of the antenna board.

In this structure, the antenna structure adopts the IFA, and an equivalent inductance loop formed by grounding the IFA can maximumly offset a capacitive influence formed between the antenna backbone and the ground, thereby reducing an influence of the antenna detuning due to the product suffering changes in an external magnetic field environment. Furthermore, using the larger bandwidth characteristics of the IFA, it can also reduce an influence of the external environment on the antenna frequency. Next, adopting the IFA whose backbone is distributed in a serpentine shape helps to increase a size of the antenna on an antenna board with a same size. In this structure, an arrangement of the fixed pin contributes to the stable installation of the antenna structure.

In some embodiments, the antenna board has a double-sided layout, two sides of the antenna board are connected through via holes, and the Bluetooth antenna is tiled between a top surface and a bottom surface of the PCB.

In this structure, the double-sided layout can effectively increase a length and a gain of the Bluetooth antenna, and improve the directivity of the antenna.

In some embodiments, a length of the Bluetooth antenna ranges from 28 mm to 33.5 mm.

In this structure, the Bluetooth antenna with a length range of 29 mm˜30 mm can ensure that the Bluetooth works in a frequency range of 2400 MHz˜2483 MHz.

In some embodiments, a length of the Bluetooth antenna is 29.3 mm.

In this structure, the Bluetooth antenna with a length of 29.3 mm can ensure the maximum coverage of the Bluetooth working frequency band, which is the optimal length value.

In some embodiments, a thickness of the antenna board ranges from 0.6 mm to 2.0 mm.

The present application also discloses a Bluetooth sensor in TPMS, including a battery, a tire pressure sensor main board, and the antenna structure as described above, where the antenna structure is vertically installed on the tire pressure sensor main board.

In this structure, an anti-interference of the Bluetooth sensor in TPMS is effectively improved by setting an independent antenna structure, which makes the Bluetooth sensor in TPMS more adaptable to changes in internal and external environments of tires and maximizes the signal radiation efficiency.

In some embodiments, the ground pin on the antenna board is connected with laid copper for grounding on the tire pressure sensor main board, and the signal feed point is connected with a radio frequency network unit on the tire pressure sensor main board.

In some embodiments, the fixed pin is inserted into a mounting hole reserved on the tire pressure sensor main board and fixedly connected with the tire pressure sensor main board.

In this structure, since the tire pressure sensor is installed in the tire, the tire rotates or collides at high speed during the running of the vehicle, which will generate strong mechanical stress, the setting of the fixed pin helps to increase the mechanical strength of the antenna structure.

The present application creatively builds an IFA on a PCB to form an antenna board, and applies the antenna board in a Bluetooth sensor to send and receive Bluetooth signals, thereby constituting a significant difference from the traditional antenna and Bluetooth sensor solutions. Based on this implementation, the present application can achieve the following beneficial effects:
(1) by adopting the Bluetooth sensor of the present application, when the S11 10 dB bandwidth is 2.34˜2.51 GHz, the Bluetooth working frequency band is completely covered, and sufficient bandwidth margin is maintained to ensure that when the external environment of the antenna changes, the antenna resonant frequency still works in the Bluetooth frequency band;
(2) when the Bluetooth center frequency is 2.44 GHz, the standing wave ratio can reach 1.005, which is infinitely close to 1, which means that the impedance of the network line is nearly completely matched with the impedance of the antenna, and all high-frequency energy is radiated by the antenna without energy reflection loss;
(3) compared with the tire pressure Bluetooth sensor in the related art, when installing this product provided by the present application in the tire, when the tire pressure sensor mainboard is at the same position in the tire, such as downwards touching the ground, and a Bluetooth receiving device is at a distance of 30 m from the product under test, the product of the present application has an amplitude of the RSSI (Received Signal Strength Indicator) signal being about −78 dBm˜−82 dBm, while the signal amplitude of the related tire pressure Bluetooth sensor is only −86 dBm˜−92 dBm. The actual test results show that the signal radiation power of the product provided by the present application is much higher than that of the related technology, which meets the requirements of the design theory.

### BRIEF DESCRIPTION OF THE DRAWINGS

The accompanying drawings are used to provide a further understanding of the present application, and constitute a part of the specification, and are used together with the embodiments of the present application to explain the present application, and do not constitute a limitation to the present application.

FIG. 1 is a distribution diagram of an inverted F right-angle Bluetooth antenna.

FIG. 2 is a distribution diagram of an inverted F Bluetooth antenna distributed in a serpentine shape.

FIG. 3 is an equivalent schematic diagram of a Bluetooth antenna.

FIG. 4 is a diagram of a magnetic field distribution of a Bluetooth antenna.

FIG. 5 is an actual measurement diagram of return loss S11.

FIG. 6 is an actual measurement diagram of a standing wave ratio SWR.

FIG. 7 is a structure schematic diagram (1) of a Bluetooth sensor in TPMS.

FIG. 8 is a structure schematic diagram (2) of a Bluetooth sensor in TPMS.

FIG. 9 is a top view of FIG. 7 and FIG. 8.

FIG. 10 is a bottom view of FIG. 7 and FIG. 8.

### DETAILED DESCRIPTION OF THE EMBODIMENTS

Exemplary embodiments of the present application will be described in more detail below with reference to the accompanying drawings. Although exemplary embodiments of the present application are shown in the drawings, it should be understood that the present application can be embodied in various forms and should not be limited to the embodiments set forth herein. On the contrary, these embodiments are provided such that the present application can be more thoroughly understood, and the scope of the present application can be fully conveyed to those skilled in the art.

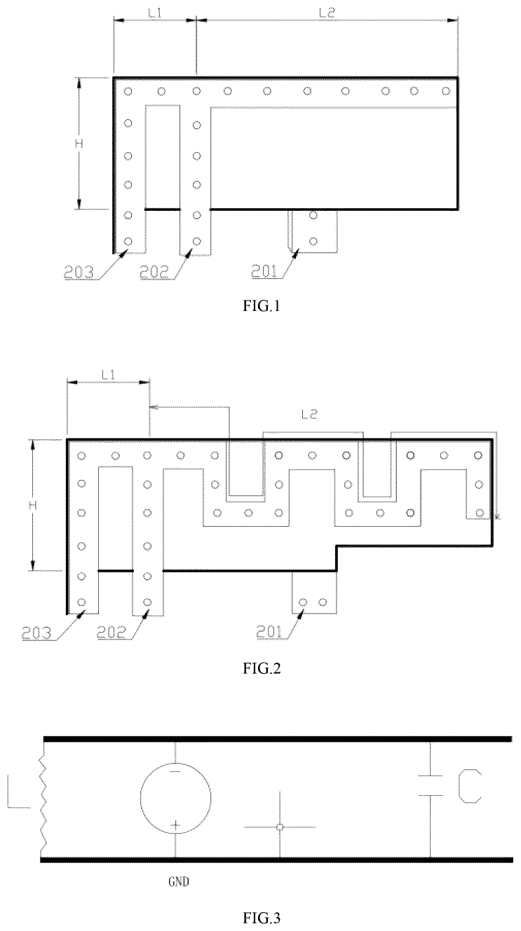

An antenna structure for a Bluetooth sensor in a Tire Pressure Monitor System (TPMS), including an antenna board and a Bluetooth antenna on the antenna board. The Bluetooth sensor and antenna may operate according to one or more of the BLUETOOTH Core Specifications, such as version 5.4 (dated 7 Feb. 2023). The antenna board is a PCB, and the Bluetooth antenna arranged thereon can be an IFA with a backbone distributed in straight line or a backbone distributed in a serpentine shape, as shown in FIG. 1 and FIG. 2. Since the inverted F antenna distributed in a serpentine shape helps to increase the size of the antenna, it can be used as a preferred solution. The PCB has a single-sided layout with a Bluetooth antenna arranged in a single-sided layout. The PCB can also have a double-sided layout with the Bluetooth antenna arranged in a double-sided layout; the two sides of the PCB are connected through a number of via holes, which can effectively increase a length and a gain of the Bluetooth antenna and improve the directivity of the antenna. A thickness of the PCB ranges from 0.6 mm to 2.0 mm.

In some embodiments, the Bluetooth antenna includes a first radiating part, a third radiating part extending along a first direction, a second radiating part and a fourth radiating part extending along a second direction. The first direction is perpendicular or approximately perpendicular to the second direction. A first end of the first radiating part is connected with a head of the second radiating part, the fourth radiating part is connected with an end of the second radiating part, the third radiating part is connected with a head of the fourth radiating part, and a length of the first radiating part and a length of the third radiating part is H, a length of the second radiating part is L1, and a length of the fourth radiating part is L2.

In a case that the fourth radiating part extends straight along the second direction. The overall Bluetooth antenna is in a reverse F shape inclined to one side. In another case, the fourth radiating part has a straight-turning serpentine distribution along the second direction, turning towards the first direction. This distribution helps to increase antenna length and gain, as well as antenna directivity.

The Bluetooth antenna uses a portion of the first radiating part protruding from the antenna board as a ground pin 203, which is connected with the ground during installation to form an equivalent inductive loop, as shown in FIG. 4. Since the first radiating part is at the end position of the antenna, that is, at the lowest point of the magnetic field, connecting the first radiating part of the antenna to the ground through the ground pin at the lowest point will not affect the radiation performance of the antenna, and at the same time can alleviate the difficulty of antenna impedance matching. A horizontal branch of the antenna in the extension direction, that is, the fourth radiation part, is the signal radiation end, which forms a capacitive effect with the external metal, the ground and other environments. Since the IFA has the first radiation part, it can maximumly offset the capacitive effect generated by the horizontal branch and the ground. For the use of sensors, the directly advantage is that it can minimize the detuning effect caused by changes in the antenna surrounding environment of the product in actual use, such as, when the tire pressure sensor is in the vehicle tire, the magnetic field changes caused by the contact between the antenna and the metal wheel and the ground outside the tire, ensuring that the working resonant frequency and impedance characteristics of the product are at the set frequency point. The Bluetooth antenna uses the portion of the third radiating part protruding from the antenna board as a signal feed point 202, and a fixed pin 201 is protruded from the same side of the antenna board where the signal feed point is located.

The length of the Bluetooth antenna is a quarter wavelength, that is, (H+L1+L2)=λ/4, where λ=(C/f1)*0.96. C=light speed, f1=Bluetooth frequency, and Bluetooth uses GFSK (Gaussian Frequency Shift Keying) modulation, its working frequency ranges from 2400 MHz to 2483 MHz, and the antenna λ/4 length ranges from 29 mm to 30 mm. In order to ensure that Bluetooth covers the above-mentioned frequency bands, the Bluetooth frequency f1 is taken as 2450 MHz, and the optimum antenna length is 29.3 mm. Similarly, the resonant frequency f2=C/4*(L1+L2+H) of the antenna also falls within the working frequency band of Bluetooth. It can be seen that 29.3 mm is the theoretical optimum value of the antenna length. However, considering that there may be errors in the processing processes such as cutting and bending of metal materials for producing Bluetooth antennas, the antenna length can also be set to 28˜36 mm. In some embodiments, the antenna length can be 28 mm˜33.5 mm. In some embodiments, as shown in FIG. 1, for the IFA whose backbone is distributed in a straight line, where H=6 mm˜12 mm. L1=2 mm˜6 mm, and L1=12 mm˜18 mm; for the IFA whose backbone is distributed in a serpentine shape as shown in FIG. 2, where H=3 mm˜6 mm, L1=2 mm˜4 mm, L1=18 mm˜26 mm, there is no limit to the number of bends in the serpentine distribution, as long as the length of the antenna is met.

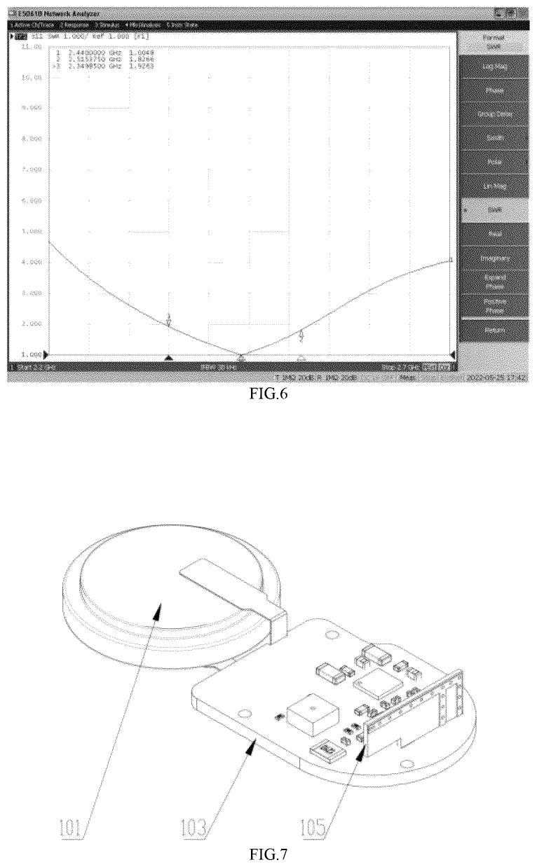

As shown in FIG. 5, it can be seen from a vector network analyzer that the S11 10 dB bandwidth is 2.34 GHz˜2.51 GHz, which completely covers the Bluetooth working frequency band, and maintains sufficient bandwidth margin, which can ensure that when the external environment of the antenna changes, the antenna resonant frequency still working on the Bluetooth band. As show in FIG. 6, when the Bluetooth center frequency is 2.44 GHz, the Standing Wave Ratio can reach 1.005, which is infinitely close to 1, which means that the impedance of the network line is nearly completely matched with the impedance of the antenna, and all high-frequency energy is radiated by the antenna without energy reflection loss.

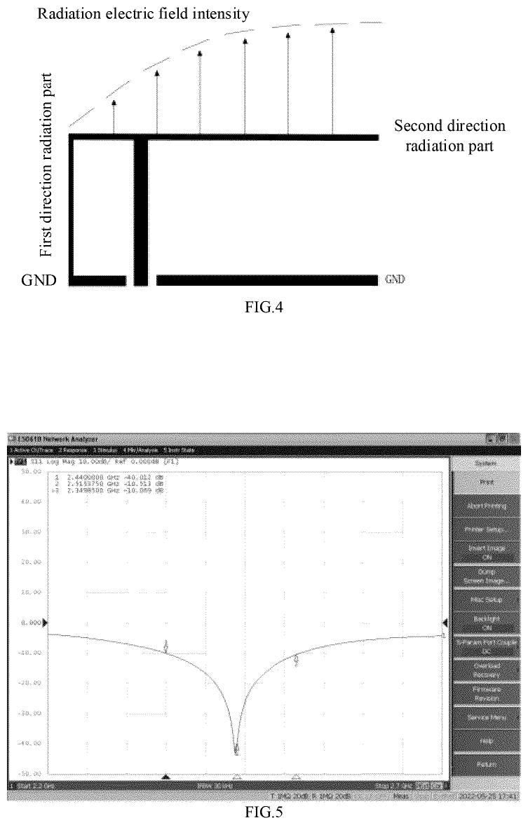

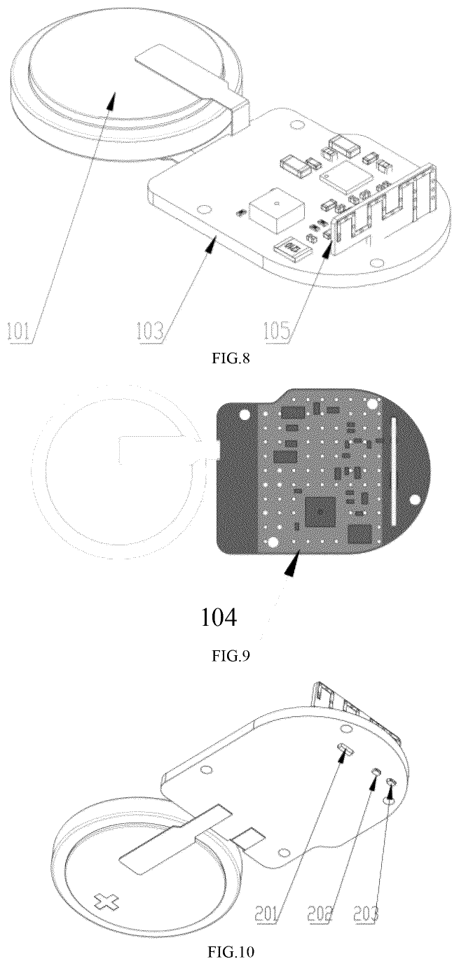

A Bluetooth sensor in TPMS including the above antenna structure further includes a battery 101 and a tire pressure sensor main board 103, the battery supplies power to the tire pressure sensor main board, and the tire pressure sensor main board completes signal radiation through the Bluetooth antenna. As shown in FIG. 7 to FIG. 10, an antenna board 105 is installed vertically on an upper surface of the tire pressure sensor main board, and the surface of the tire pressure sensor main board is laid with copper for grounding. Components installed on the tire pressure sensor main board are all disposed at inner-side of the antenna board, and at position 104 where copper is laid. There are also a plurality of via holes between the upper and lower panels to ensure that the potential of the radio frequency ground is equal to the potential of the ground of the entire area, thereby increasing the resonant impedance matching of the antenna and facilitating debugging. The ground pin 203 on the antenna board is connected with the copper laid on the tire pressure sensor main board. For radio frequency signals, grounding is not equal to short circuit. The first radiating part is equivalent to an inductor; and the fourth radiating part is a signal radiating end, and with the external metals, the ground and other environments to form capacitance effects, as shown in FIG. 3. The signal feed point 202 is connected with a radio frequency network unit on the tire pressure sensor main board. The fixed pin 201 is inserted into a mounting hole reserved on the tire pressure sensor main board and fixedly connected with the tire pressure sensor main board. The fixed pin is configured to increase the mechanical strength of the antenna board to overcome strong mechanical stress due to the high-speed rotation or collision of the tire during the operation of the vehicle.

Compared with the tire pressure Bluetooth sensor in the related art, when installing this product provided by the present application in the tire, when the tire pressure sensor main board is at the same position in the tire, such as downwards touching the ground, and a Bluetooth receiving device is at a distance of 30 m from the product under test, the product provided by the present application has an amplitude of the RSSI signal being about −78 dBm˜−82 dBm, while the signal amplitude of the related tire pressure Bluetooth sensor is only −86 dBm˜−92 dBm. The actual test results show that the signal radiation power of the product provided by the present application is much higher than that of the related technology, which meets the requirements of the design theory.

Obviously, those skilled in the art can make various changes and modifications to the application without departing from the spirit and scope of the application. In this way, if these modifications and variations of the present application fall within the scope of the claims of the present application and their equivalent technologies, the present application is also intended to include these modifications and variations.

1. An antenna structure for a Bluetooth sensor in a tire pressure monitoring system (TPMS), comprising an antenna board and a Bluetooth antenna on the antenna board, wherein the Bluetooth antenna is an Integrated Feed Antenna (IFA) with a backbone distributed in a straight line or a backbone distributed in a serpentine shape; wherein the antenna board is a Printed Circuit Board (PCB), comprising a ground pin, a signal feed point and a fixed pin that are protruded from an edge of the antenna board; and
wherein the ground pin and the signal feed point are connected with the Bluetooth antenna.

2. The antenna structure for the Bluetooth sensor in the TPMS according to claim 1, wherein the antenna board has a double-sided layout, two sides of the antenna board are connected through via holes, and the Bluetooth antenna is arranged between a top surface and a bottom surface of the PCB.

3. The antenna structure for the Bluetooth sensor in the TPMS according to claim 1, wherein a length of the Bluetooth antenna ranges from 28 mm to 33.5 mm.

4. The antenna structure for the Bluetooth sensor in the TPMS according to claim 1, wherein a length of the Bluetooth antenna is 29.3 mm.

5. The antenna structure for the Bluetooth sensor in the TPMS according to claim 1, wherein a thickness of the antenna board ranges from 0.6 mm to 2.0 mm.

6. A Bluetooth sensor in a tire pressure monitoring system (TPMS), comprising a battery, a tire pressure sensor main board, and an antenna structure for the Bluetooth sensor in the TPMS, wherein the antenna structure is vertically installed on the tire pressure sensor main board;
wherein the antenna structure comprises an antenna board and a Bluetooth antenna on the antenna board, wherein the Bluetooth antenna is an Integrated Feed Antenna (IFA) with a backbone distributed in a straight line or a backbone distributed in a serpentine shape; wherein the antenna board is a Printed Circuit Board (PCB), comprising a ground pin, a signal feed point and a fixed pin that are protruded from an edge of the antenna board; and wherein the ground pin and the signal feed point are connected with the Bluetooth antenna.

7. The Bluetooth sensor in the TPMS according to claim 6, wherein the ground pin on the antenna board is connected with laid copper for grounding on the tire pressure sensor main board, and the signal feed point is connected with a radio frequency network unit on the tire pressure sensor main board.

8. The Bluetooth sensor in the TPMS according to claim 6, wherein the fixed pin is inserted into a mounting hole reserved on the tire pressure sensor main board and fixedly connected with the tire pressure sensor main board.

9. The Bluetooth sensor in the TPMS according to claim 6, wherein the antenna board has a double-sided layout, two sides of the antenna board are connected through via holes, and the Bluetooth antenna is arranged between a top surface and a bottom surface of the PCB.

10. The Bluetooth sensor in the TPMS according to claim 6, wherein a length of the Bluetooth antenna ranges from 28 mm to 33.5 mm.

11. The Bluetooth sensor in the TPMS according to claim 6, wherein a length of the Bluetooth antenna is 29.3 mm.

12. The Bluetooth sensor in the TPMS according to claim 6, wherein a thickness of the antenna board ranges from 0.6 mm to 2.0 mm.
